(19) United States
(12) Patent Application Publication
(10) Pub. No.: US 2013/0040862 A1
(43) Pub. Date: Feb. 14, 2013

(54) MULTI-PILLAR STRUCTURE FOR MOLECULAR ANALYSIS

(71) Applicants: Zhiyong Li, Redwood City, CA (US); Min Hu, Sunnyvale, CA (US); Fung Suong Ou, Palo Alto, CA (US); Wei Wu, Palo Alto, CA (US); R. Stanley Williams, Portola Valley, CA (US)

(72) Inventors: Zhiyong Li, Redwood City, CA (US); Min Hu, Sunnyvale, CA (US); Fung Suong Ou, Palo Alto, CA (US); Wei Wu, Palo Alto, CA (US); R. Stanley Williams, Portola Valley, CA (US)

(21) Appl. No.: 13/636,799

(22) PCT Filed: Apr. 20, 2010
(86) PCT No.: PCT/US10/31790

§ 371 Date: Sep. 24, 2012

(51) Int. Cl. C40B 40/14; C40B 50/14; C40B 40/18; C40B 40/04; B82Y 15/00

(52) U.S. Cl. 506/20; 506/22; 506/15; 506/30; 977/920; 977/762

(57) ABSTRACT

A multi-pillar structure for molecular analysis is provided. The structure comprises at least two nanopoles, each nanopole attached at one end to a substrate and freely movable along its length. The opposite ends of the at least two nanopoles are each capable of movement toward each other to trap at least one analyte molecule at their opposite ends. Each nanopole is coated with a metal coating. An array of such multi-pillar structures is also provided. A method for preparing the multi-pillar structure is further provided.

### CROSS-REFERENCE TO RELATED APPLICATION

The present application is related to U.S. patent application Ser. No. ______ [200904951-1] by Zhiyong Li et al, filed on even date herewith, entitled “A SELF-ARRANGING, LUMINESCENCE-ENHANCEMENT DEVICE FOR SURFACE-ENHANCED LUMINESCENCE” and assigned to the same assignee as the present application.

### BACKGROUND ART

Embodiments of the present invention relate generally to systems for performing molecular analysis, such as surface-enhanced Raman spectroscopy (SERS), enhanced fluorescence, enhanced luminescence, and plasmonic sensing, among others.

With specific regard to SERS, Raman spectroscopy is a spectroscopic technique used in condensed matter physics and chemistry to study vibrational, rotational, and other low-frequency modes in molecular systems. In a Raman spectroscopic experiment, an approximately monochromatic beam of light of a particular wavelength range passes through a sample of molecules and a spectrum of scattered light is emitted. The spectrum of wavelengths emitted from the molecule is called a “Raman spectrum” and the emitted light is called “Raman scattered light.” A Raman spectrum can reveal electronic, vibrational, and rotational energies levels of a molecule. Different molecules produce different Raman spectrums that can be used like a fingerprint to identify molecules and even determine the structure of molecules.

Raman spectroscopy is used to study the transitions between molecular energy states when photons interact with molecules, which results in the energy of the scattered photons being shifted. The Raman scattering of a molecule can be seen as two processes. The molecule, which is at a certain energy state, is first excited into another (either virtual or real) energy state by the incident photons, which is ordinarily in the optical frequency domain. The excited molecule then radiates as a dipole source under the influence of the environment in which it sits at a frequency that may be relatively low (i.e., Stokes scattering), or that may be relatively high (i.e., anti-Stokes scattering) compared to the excitation photons. The Raman spectrum of different molecules or matters has characteristic peaks that can be used to identify the species. As such, Raman spectroscopy is a useful technique for a variety of chemical or biological sensing applications. However, the intrinsic Raman scattering process is very inefficient, and rough metal surfaces, various types of nano-antennas, as well as waveguiding structures have been used to enhance the Raman scattering processes (i.e., the excitation and/or radiation process described above).

The Raman scattered light generated by a compound (or ion) adsorbed on or within a few nanometers of a structured metal surface can be 10³-10¹⁴ times greater than the Raman scattered light generated by the same compound in solution or in the gas phase. This process of analyzing a compound is called surface-enhanced Raman spectroscopy (“SERS”). In recent years, SERS has emerged as a routine and powerful tool for investigating molecular structures and characterizing interfacial and thin-film systems, and even enables single-molecule detection. Engineers, physicists, and chemists continue to seek improvements in systems and methods for performing SERS.

Most SERS systems only enhance the electro-magnetic field at certain hot spots. While this can be very desirable, in many cases, the analytes are spread evenly on the SERS substrate, such as by simple adsorption. However, only a small fraction of the analytes actually populates the hot spots.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIGS. 1A-1H depict a variety of multi-pillar structures, in accordance with embodiments of the invention.

FIG. 2A is a line drawing of a photomicrograph of a top plan view of an array of several four-pillar structures, in accordance with embodiments of the invention.

FIG. 2B, on coordinates of intensity (in arbitrary units) and Raman shift (in cm⁻¹), is a plot of the intensity of a Raman signal from an array of multi-pillar structures comprising four pillars each, in accordance with embodiments of the invention, versus a prior random cone formed on a mirror by nanoimprint lithography.

FIG. 2C is line drawing of a photomicrograph of an enlarged view of an array of multi-pillar structures, similar to that of FIG. 2A, showing a four-pillar structure, a six-pillar structure, and a nine-pillar structure.

FIGS. 3A-3B depict modulation of separation of pillars in a multi-pillar structure, here comprising two pillars, in accordance with embodiments of the invention.

FIGS. 4A-4B depict embodiments of integrated structures combining the multi-pillar structures with other optics, in accordance with embodiments of the invention.

FIGS. 5A-5B each depict a schematic view of a sensing apparatus, according to an embodiment of the present invention.

### BEST MODES FOR CARRYING OUT THE INVENTION

Reference is made now in detail to specific embodiments, which illustrates the best mode presently contemplated by the inventors for practicing the invention. Alternative embodiments are also briefly described as applicable.

A new class of SERS structures is disclosed which is based on multi-pillar, or finger, structures, comprising a plurality (at least two) of nanopoles, that, in the presence of an analyte, look like teepees. Indeed, the nanopoles (two, three, four, or more) tend to lean in toward each other when exposed to an analyte. The structure can be rationally designed according to the SERS requirement and can be mass fabricated with 3-D imprinting methods or roll-to-roll processes. An array of groups of nanopoles may provide improved sensitivity of the SERS sensor and are easy manufacturable.

Rational engineering of SERS structures has been of great interest for broad application of chemical/biological sensing. Identifying the optimal nanostructure for SERS applications has always been the ultimate goal in this field. Bottom-up synthesized nanocrystals of various shapes, such as wires, cubes, multi-pods, stars, core-shells, bowties, etc. have been studied extensively. On the other hand, top-down fabricated nanostructures, such as nanocones, nano-grass, grating/antenna hybrid structures have also been proposed and studied. Here, a new type of SERS structure is presented which can be easily mass-manufacturable and offers a great amount of flexibility for optimization as ultrasensitive SERS sensors.

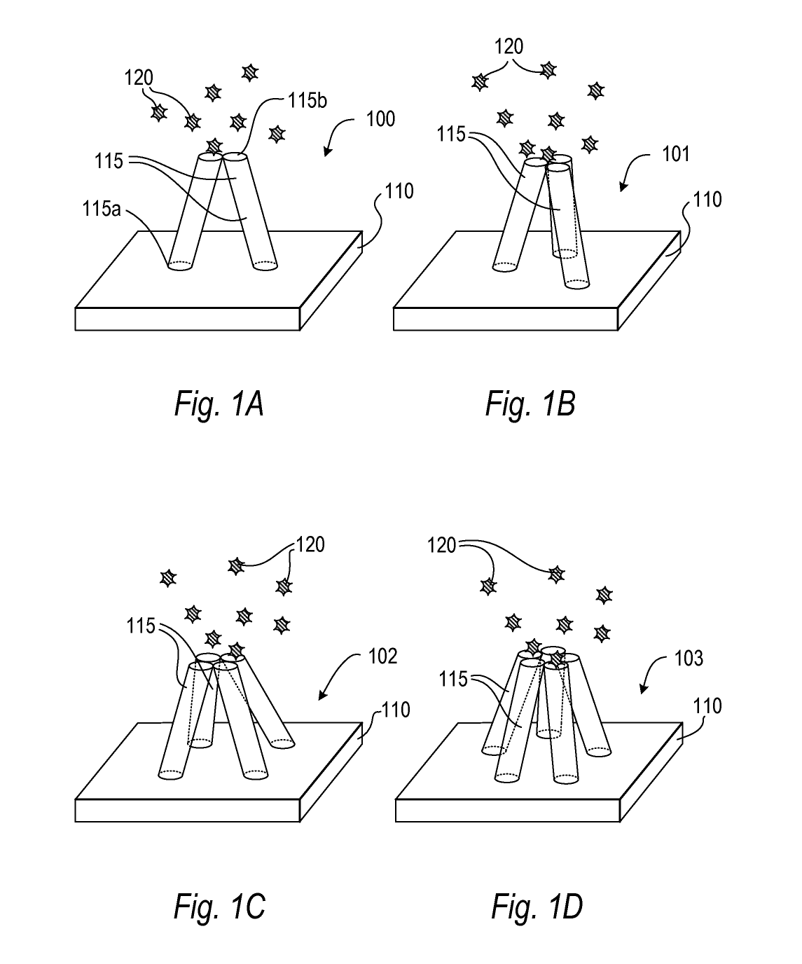

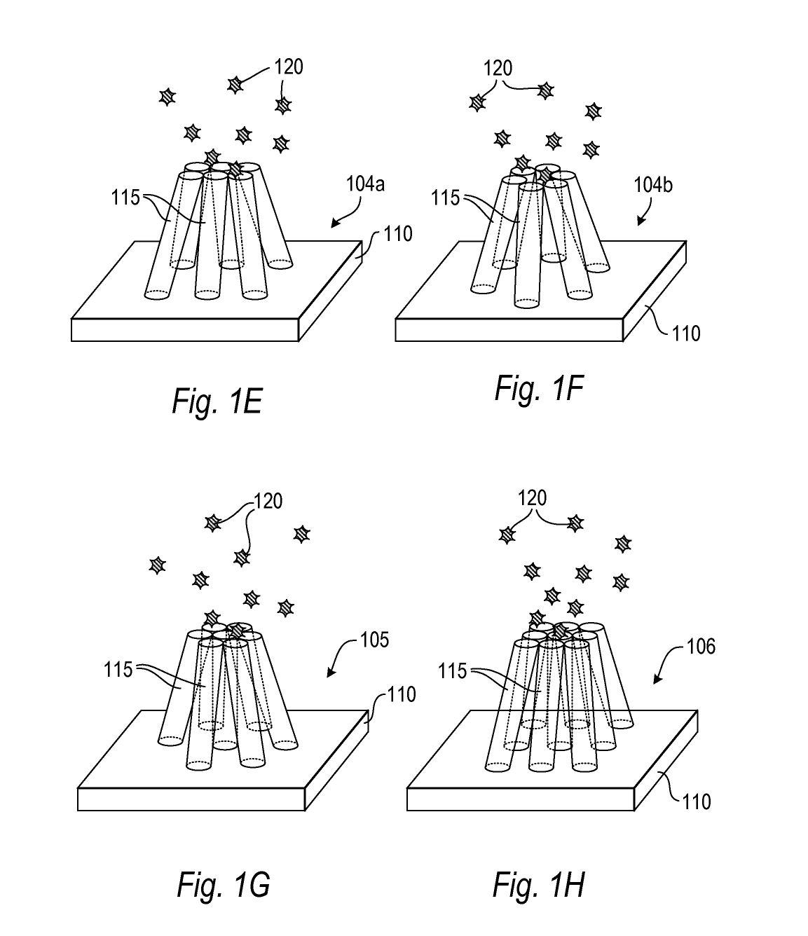

FIGS. 1A-1H depict various teepee-like structures 100-106, each comprising a substrate 110 supporting a plurality (at least two) nanopoles 115 to form a teepee-like structure, defined herein as a structure in which the poles are each attached to the substrate at one end 115a and lean in to each other at an angle to touch at their tips their other end 115b, as shown in FIG. 1A. The height of the nanopoles, or pillars, or fingers, 115 is in the range of about 50 nm to 2 μm and their diameter is in the range of about 10 nm to 1 μm.

FIG. 1A shows two such nanopoles 115, touching at their tips to form a teepee structure 100. Likewise, FIG. 1B shows three nanopoles, forming structure 101. FIG. 1C shows four nanopoles, forming structure 102. FIG. 1D shows five nanopoles, forming structure 103. FIGS. 1E and 1F show six nanopoles, in two different configurations, two parallel lines of three nanopoles each (FIG. 1E) and a hexagon arrangement (FIG. 1F), forming structures 104a and 104b, respectively. As the number of nanopoles increases, different arrangements may be employed, such as polygonal, at least two parallel lines, etc., so long as the poles in a particular arrangement all touch at a portion of their tips 115b. FIG. 1G shows seven nanopoles, forming structure 105. FIG. 1H shows nine nanopoles, forming structure 106. The arrangements depicted in FIGS. 1A-1H are exemplary only, and other configurations of nanopoles, number of nanopoles, etc., may be employed.

The nanopoles 115 may be circular in cross-section, as shown here, or a non-symmetrical shape, such as ovoid, which may enable engineering how the nanopoles are closed up at their tips 115b.

In each instance, an analyte, represented here as a plurality of molecules 120 in solution (not shown) is associated with the nanopoles 115, typically at or near their tips 115b. While the analyte 120 may be distributed over the substrate 110 and nanopoles 115, they are more likely to associate with the tips 115b of the nanopoles, due to (1) the presence of a SERS-active metal, discussed below, on the surfaces of the nanopoles and (b) the surface plasmon effect, which tends to concentrate the analyte at the tips under laser illumination.

Microcapillary forces are typically used to create the teepee-like structures 100-106. Other non-limiting examples, such as e-beam, ion-beam or electric charge effect, can also be utilized to induce the formation of the teepee-like structures 100-106. The nanopoles, as initially created, are vertical, free-standing posts that may be formed by a variety of techniques, such as 3-D imprinting methods, embossing, CVD growth, etching, or roll-to-roll processes.

The structure 100-106 is then exposed to an analyte in solution, such as water. Upon drying, microcapillary forces pull neighboring nanopoles, or pillars, 115 together so that their tips 115b touch. During this process, molecules of the analyte 120 tend to get trapped between neighboring pillars 115. The separation of the pillars at their tips then depends on the size of the molecule. This process provides a well-controlled uniformity of the formation of the structures 100-106.

It appears that the formation of the structures 100-106 can be permanent, relying on van der Waals interactions to hold the pillars together at their tips. This may happen after drying and even re-immersion in a solvent.

On the other hand, the formation of the structures 100-106 may be reversible, possibly using an electromagnetic force, mechanical force, or electric charge repelling to open the structure back up to revert to the original vertical, free-standing nanopoles.

There is an enhanced electromagnetic field that is formed in the gap between the nanopoles at their tips. The magnitude of the enhancement of the EM field depends on the size of the gap, which, as discussed above, depends on the size of the molecule trapped in the gap.

As the size of the gap decreases, the EM field increases. For example, there is an increase of about 1,000× in the EM field as the gap is decreased from 10 nm to less than 1 nm between two metal nanospheres. It is known that the SERS effect is a function of the 4^{th} power of the EM field enhancement. Thus, an increase of 10³ as the gap is decreased results in a 10¹² improvement in Raman signal strength.

Gaps, as mentioned above, are approximately molecular size (the size of the molecules trapped). Molecular sizes may be on the order of less than 1 nm, typically about 0.5 nm.

Consider an organic molecule with carbon-based groups, to which thio groups, e.g., —SH, are attached. These thio groups may then attach to the metal, e.g., gold or silver, coating the nanopoles 115. Thus, gap sizes on the order of 5 nm, 2-3 nm, 1 nm, and the like may be obtained, depending on the size of the molecule and the attaching groups present.

The greater the number of nanopoles, the greater the number of molecules that can be trapped. For example, nine nanopoles will trap more molecules than two or three nanopoles. Yet, two or three nanopoles will take less real estate on the substrate than eight or nine nanopoles. Thus, there is a tradeoff to be made between the desire for more hot spots versus the fact that too high a density results in a decrease in signal response.

The configuration 100-106 obtained is controlled by the initial separation of the nanopoles 115, as is discussed further below. The nanopoles 115 may be spaced apart by a distance in the range of 10 to 500 nm, as measured at the base.

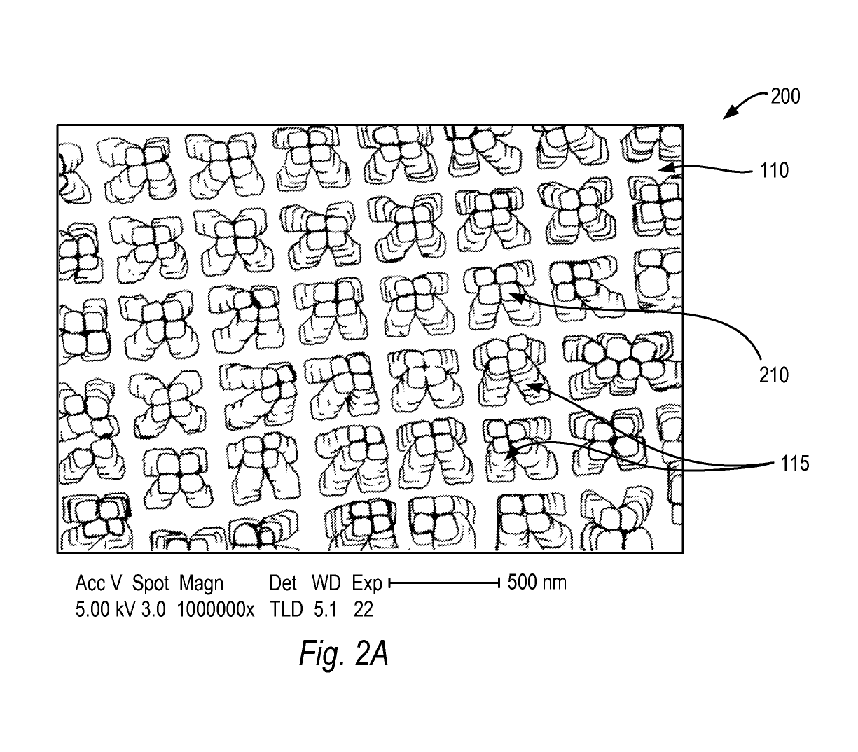

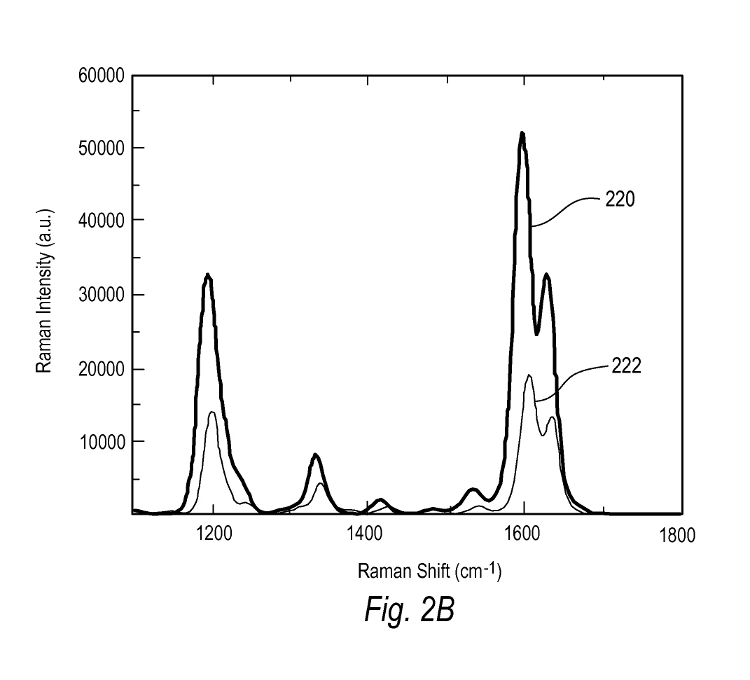

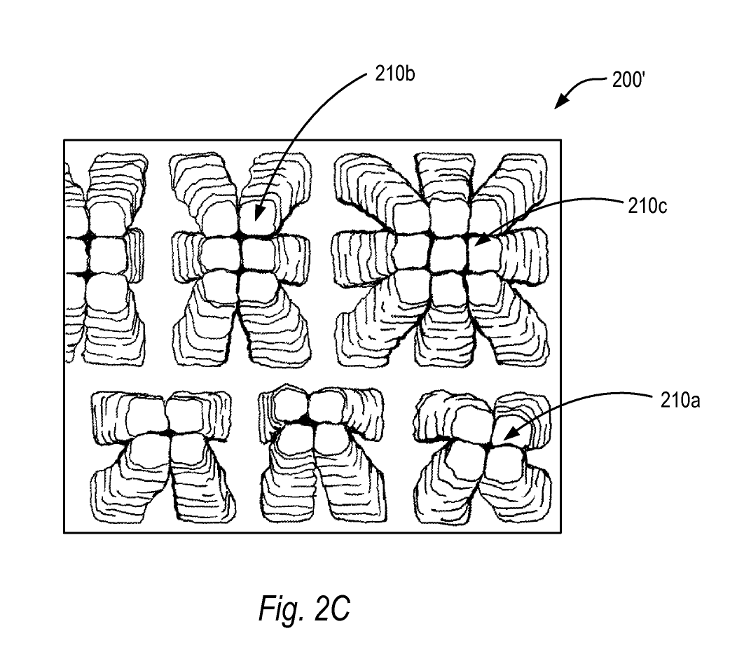

FIG. 2A is a photomicrograph (top view) of an array 200 of nanopoles 115, each unit 210 of the array comprising four such nanopoles. The four nanopoles 115 in each unit 210 are seen to be angled in toward the center of the unit, with the tips of the nanopoles touching at their tops.

In FIG. 2A, the nanopoles 115 each had a diameter of 100 nm and a separation of 100 nm. Thus, the pitch was 200 nm. The height of the nanopoles 115 was 700 nm.

FIG. 2B is a plot on coordinates of Raman intensity (in arbitrary units) versus Raman shift (in cm⁻¹) and is a comparison of the intensity of a Raman signal from an array of multi-pillar structures comprising four pillars each (FIG. 2A) versus a prior random cone formed on a mirror by nanoimprint lithography. It can be seen that the structure disclosed herein provides a substantial increase in intensity of the Raman signal.

FIG. 2C is an enlargement of an area 200′ of nanopoles 115, which, unlike the region depicted in FIG. 2A, resulted in a variety of structures. Specifically, the structures included four nanopoles 210a, six nanopoles 210b, and nine nanopoles 210c, among others. This was essentially a random distribution of different size structures, compared to FIG. 2A, which depicts an ordered distribution of structures of the same size. As indicated above, the initial separation of the nanopoles can be used to control the final desired configuration. By choosing the proper separation between the neighboring groups of the poles to be slightly larger than the distance between the nanopoles within the group can lead to the uniform control of the final configuration.

In some embodiments, the nanopoles may comprise a polymer, such as a resist, coated with a SERS-active metal, such as gold, silver, copper, platinum, aluminum, etc. or the combination of those metals in the form of alloys. The SERS active metal can be coated over the entire nanopoles 115 or can be selectively coated on the tips 115b of the nanopoles. In addition, the SERS active metal can be a multilayer structure, for example, 10 to 100 nm silver layer with 1 to 50 nm gold over-coating, or vice versa. Alternatively, the SERS active metal can be further coated with a thin dielectric layer, or functional coating, such as ALD-grown silicon oxide or aluminum oxide, titanium oxide, etc. The functional coating may provide selective trapping and sensing of analyte molecules. Furthermore, a self-assembled molecular layer of probe species can be formed on the tip of the nanopoles.

The use of a polymer renders the nanopoles sufficiently flexible to permit the bending so that the tips meet at the top of the structure. Examples of suitable polymers include, but are not limited to, polymethyl methacrylate (PMMA), polycarbonate, siloxane, polydimethylsiloxane (PDMS), photoresist, nanoimprint resist, and other thermoplastic polymers and UV curable materials comprising one or more monomers/oligomers/polymers. The nanopoles may alternatively comprise an inorganic material having sufficient flexibility to bend. Examples of such inorganic materials include silicon oxide, silicon, silicon nitride, alumina, diamond, diamond-like carbon, aluminum, copper, and the like.

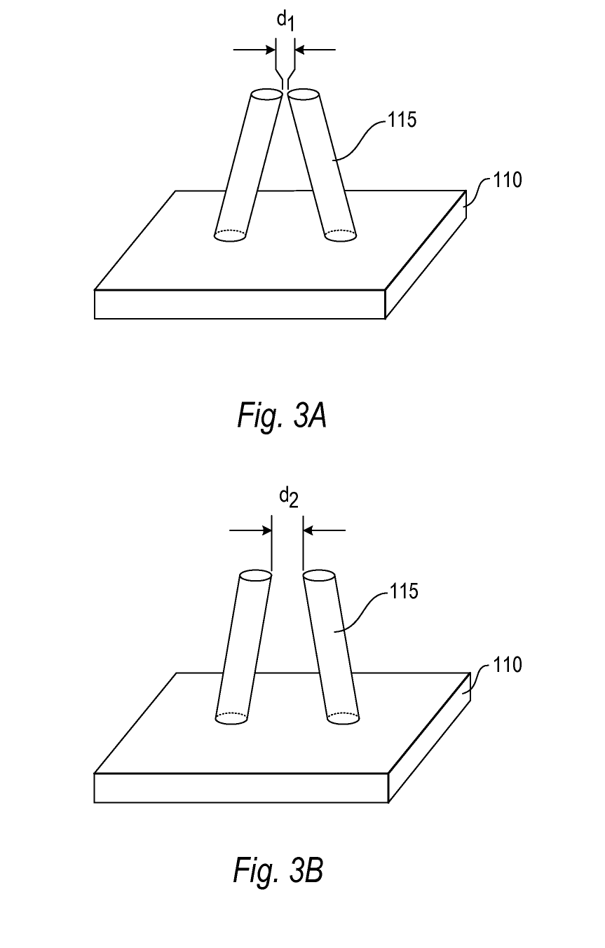

The separation of the gap of the nanopoles may be modulated. By heating the sample with either thermal or under laser of certain wavelength/pulses, the separation gap d of the tips of the poles 115 can be fine tuned. This allows one to achieve different plasmonic properties of the structure. FIG. 3A depicts a two-pole structure in which the tips of the poles 115 have a separation distance d₁. FIG. 3B depicts a similar structure in which the tips of the poles 115 have a separation distance d₂, which is different (in this case, larger) than d₁. For example, rubber has a linear thermal expansion of ˜10⁻⁴/C.° at 20° C. Therefore, if a rubber pillar of 100 nm length is heated from 20° C. to 120° C. with d₁ of 10 nm, then the separation can be changed from 10 nm to roughly 1 nm, for d₁ and d₂ respectively. The process can be reversible when the temperature is cooled back.

Similarly, one can engineer the materials of the nanopoles so that a proper thermal expansion or retraction can be achieved. For example, two different materials may be used to form the nanopoles so as to gain effects from heating two different materials.

Other means, such as mechanical bending, stretching/compressing, or vibrating of the substrate, electric field, or magnetic field, can also be used to modulate the structure. In particular, the substrate on which the nanopoles are formed can be a material with elastomeric property, such as PDMS, or rubber material. When a stretching or compressive force is applied to the substrate, the distance d between pole tips can be modulated, for example, between d₁ of less than 1 nm and d₂ of 5 to 10 nm.

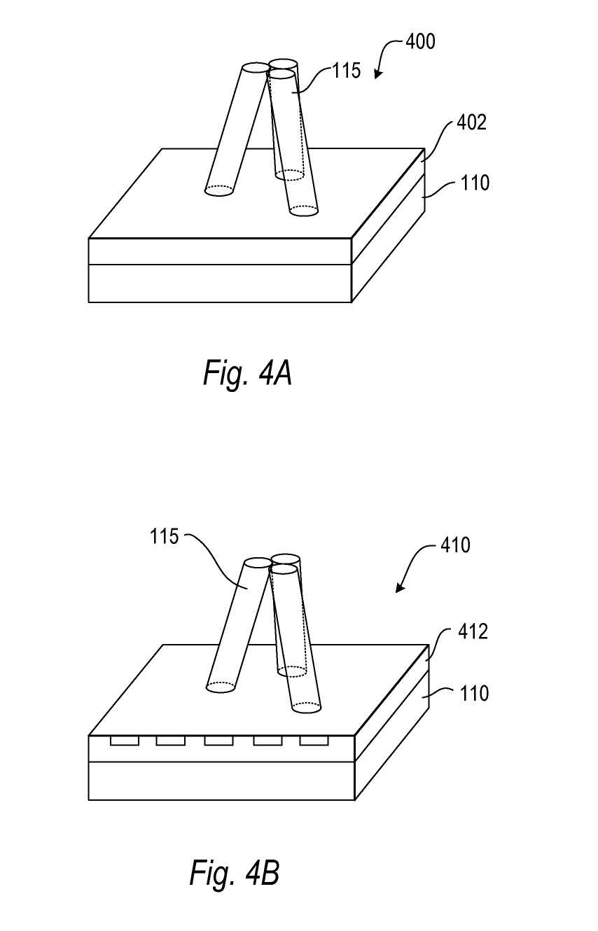

Any of the teepee-like structures 100-106 may be integrated with other optics. For example, FIG. 4A depicts a three-pole structure 400 formed on a metal mirror 402. The metal mirror 402 is in turn formed on substrate 110. The metal mirror 402 may be flat or concave. The mirror 402 can be used to reflect light into the structure 400 to thereby obtain a further increase in signal strength.

FIG. 4B depicts a three-pole structure 410 formed on a grating structure 412. The grating structure 412 is in turn formed on substrate 110. Grating structures in conjunction with SERS structures have been discussed elsewhere; see, e.g., U.S. Pat. Nos. 7,639,355 and 7,474,396. Alternatively, the structure 410 itself can be used as a grating. By proper designing the pitch of the poles or the pitch of the teepee structure along either one dimension or two dimension on the substrate surface, an amplitude modulated interference grating can be established.

A non-limiting fabrication method of an array of nanopoles on a substrate may comprise:
1. Design the desired patterns on a mold, by either E-beam lithography, photolithography, laser interference lithography, FIB (Focused Ion Beam), self-assembly of spheres, etc.
2. Transfer the pattern onto silicon, glass, or polymer substrate (PDMS, polyimide, polycarbonate, etc.).
3. Coat the nanopoles with Raman active materials, such as gold, silver, copper, etc.
4. Induce the self-assembly (moving together of the tips of the nanopoles with drying of the liquid; the microcapillary force during liquid drying will induce the self-assembly of the nanopoles into regular (e.g., FIG. 2A) or irregular (e.g., FIG. 2C) teepee-like structures.

There are several advantages derived from the formation of teepee-like structures of assemblies of nanopoles. For example, different geometries of nanopoles (e.g., two, three, etc.) can be designed. A large SERS active volume can be achieved with these 3-D structures. Plasmonic focusing/coupling can be achieved toward the tips 115b of the teepee structures. Easy integration with other optic components, such as mirrors, gratings, etc. is readily achievable. Further, fine-tuning of the tip separation is possible with thermal or laser heating, mechanical force, electric field or magnetic field for optimal SERS performance under certain incident wavelengths as well as for other optical sensing, such as fluorescence, luminescence, plasmonic resonance, scattering, etc.

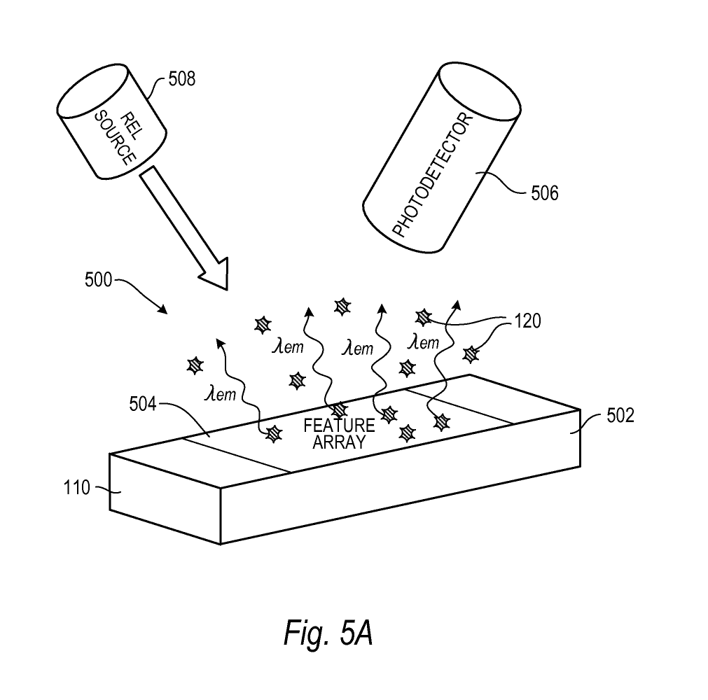

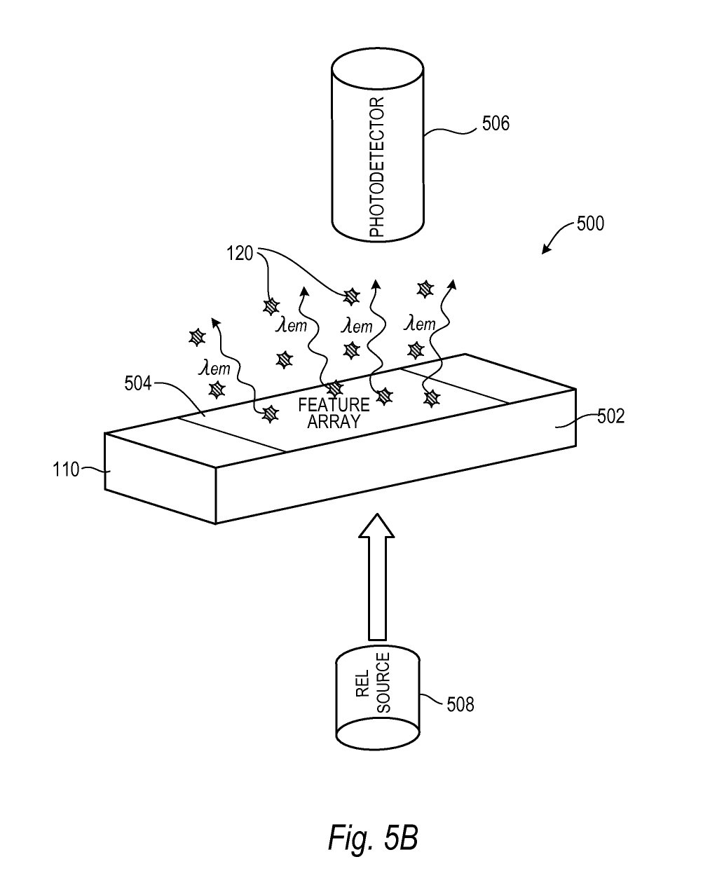

FIGS. 5A-5B show schematic representations of analyte sensors configured and operated in accordance with embodiments of the present invention. Analyte sensor 500 includes a Raman-active substrate 502 composed of an array of features 504, as described above with reference to FIGS. 1A-H, for example, a photodetector 506, and a Raman-excitation light source 508.

In the example shown in FIG. 5A, the light source 508 is positioned so that Raman-excitation light is incident directly on the array of features 504 (the nanopoles 115).

In the example shown in FIG. 5B, the light source 508 is positioned beneath the Raman-active substrate 502 so that the Raman-excitation light passes through the substrate. In this latter case, the substrate 110 may be transparent to the incident light.

In both cases, the photodetector 506 is positioned to capture at least a portion of the Raman scattered light λₑₘ emitted by an analyte on the surface of the substrate.

The intensity of the Raman scattered light may also be enhanced as a result of two mechanisms associated with the Raman-active material. The first mechanism is an enhanced electromagnetic field produced at the surface of the Raman-active substrate 502, specifically, the nanopoles 115 depicted in FIGS. 1A-1H. As a result, conduction electrons in the metal surfaces of the nano-antennae 115 are excited into an extended surface excited electronic state called a “surface plasmon polariton” or “localized surface plasmon”. Analytes 120 adsorbed on or in close proximity to the nano-antennae 115 experience a relatively strong electromagnetic field. Molecular vibrational modes directed normal to the nanopole 115 surfaces are most strongly enhanced. The intensity of the surface plasmon polariton resonance depends on many factors, including the metal material, the size and the shape of the antenna (here, nanopoles 115) as well as the separation distance.

The second mode of enhancement, charge transfer, may occur as a result of the formation of a charge-transfer complex between the surfaces of the nanopoles 115 and the analyte 120 absorbed to the nanopole surfaces. The electronic transitions of many charge transfer complexes are typically in the visible range of the electromagnetic spectrum.

The foregoing discussion has been presented in terms of SERS analysis, for the sake of convenience. However, it will be appreciated that the same multi-pillar structures can be employed in other analytical techniques, including, but not limited to, enhanced fluorescence, enhanced luminescence, and plasmonic sensing, optical scattering and/or absorption.

1. A multi-pillar structure for molecular analysis, the structure comprising at least two nanopoles each nanopole attached at one end to a substrate and freely movable along its length, the opposite ends of the at least two nanopoles each being capable of movement toward each other to trap at least one analyte molecule at their opposite ends, each nanopole coated with a metal coating.

2. The multi-pillar structure of claim 1 wherein an array of the structures on the substrate is provided.

3. The multi-pillar structure of claim 1 wherein the at least two nanopoles comprise a polymer selected from the group consisting of polymethyl methacrylate (PMMA), polycarbonate, siloxane, polydimethylsiloxane (PDMS), and photoresist.

4. The multi-pillar structure of claim 1 wherein the at least two nanopoles comprise an inorganic material selected from the group consisting of silicon oxide, silicon, silicon nitride, silicon oxynitride, alumina, diamond, diamond-like carbon, aluminum, and copper.

5. The multi-pillar structure of claim 1 wherein the at least two nanopoles comprise the same composition or different composition.

6. The multi-pillar structure of claim 1 wherein the nanopoles have a height of in the range of about 50 nm to 2 μm, a diameter in the range of about 10 nm to 1 μm, and a spacing of about 10 to 500 nm at the base of the poles.

7. The multi-pillar structure of claim 1 wherein the metal coating is selected from the group consisting of gold, silver, copper, platinum, aluminum, and alloys thereof.

8. An array of multi-pillar structures for molecular analysis, each structure in the array comprising at least two nanopoles, each nanopole attached at one end to a substrate and freely movable along its length, the opposite ends of the at least two nanopoles each being capable of movement toward each other to trap at least one analyte molecule at their opposite ends, each nanopole coated with a metal coating.

9. The array of claim 8 for molecular analysis in a SERS apparatus comprising a Raman-excitation light source and a photodetector, wherein the photodetector is on the same side of the substrate as the nanopoles and either the light source is on the same side of the substrate as the nanopoles or on the opposite side of the substrate from the nanopoles.

10. The array of claim 8 for molecular analysis in enhanced fluorescence, enhanced fluorescence, enhanced luminescence, plasmonic sensing, optical scattering and/or optical absorption.

11. A method for preparing a multi-pillar structure comprising at least two nanopoles, each nanopole attached at one end to a substrate and freely movable along its length, the opposite ends of the at least two nanopoles each being capable of movement toward each other to trap at least one analyte molecule at their opposite ends, each nanopole coated with a metal coating, the method comprising:
forming a plurality of the nanopoles on the substrate; and providing each nanopole with a metal coating.

12. The method of claim 11 further comprising:
exposing the plurality of nanopoles to an analyte in a solvent; and
removing the solvent, leaving the analyte behind on the nanopoles and causing the opposite ends of the nanopillars to move toward each other and trap at least one analyte molecule at the opposite ends.

13. The method of claim 12, comprising forming an array of nanopole structures, wherein the array comprises nanopole structures that are all the same structure or that are different structures.

14. The method of claim 11, wherein a functional coating is applied over the metal coating for selective trapping and sensing of analyte molecules.
